(19) United States
(12) Patent Application Publication
(10) Pub. No.: US 2018/0096408 A1
(43) Pub. Date: Apr. 5, 2018

(54) Software search engine program for listing,buying,selling and matching together for a lead. A Process Method for watching, buying, and selling of a product with the main differences being you choose how and if you want to communicate, and you only pay if communication is made between both parties.

(71) Applicant: Tony Ray Munson, Santa Maria, CA (US)

(72) Inventor: Tony Ray Munson, Santa Maria, CA (US)

(21) Appl. No.: 15/212,228

(22) Filed: Oct. 4, 2016

(51) Int. Cl. G06Q 30/06; G06Q 20/38

(52) U.S. Cl. CPC G06Q 30/0615; G06Q 20/383

(57) ABSTRACT

A process method including software where a search/watch engine program for listing, buying, selling and matching together for a lead is disclosed. We will allow them to list their own wants and needs and variables on the item they want. Our search/watch engine will constantly be looking for matches and then based on the users variable settings contact them with alerts/leads allowing for them to then choose a communication method on matches/leads.

A Process Method for watching, buying, and selling of a product with the main differences being you choose how and if you want to communicate, and you only pay if communication is made between both parties.

### BACKGROUND OF THE INVENTION

### Problem Solved

The listing, searching and finding the perfect match of for example an automobile, and then filtering matches based on certain criteria. And then allowing the user to choose communication methods and lead distribution to include a managed service option too.

The person searching for the item has to search several places to find what they are looking for, and then can only contact the person based on the available control of that websites forms of communication. These are not usually private. They also don't allow for continuous searching.

We will allow them to list their own wants and needs and variables on the item they want. Our search/match engine will constantly be looking for matches and then based on the users variable settings contact them with alerts allowing for them to then choose a communication method on matches/leads.

### DETAILED DESCRIPTION OF THE INVENTION

As stated above, the listing, searching and finding the perfect match of for example an automobile, and then filtering matches based on certain criteria. And then allowing the user to choose communication methods and lead distribution to include a managed service option too. The invention claimed here solves this problem.

Our web based software search/match engine will allow for buyers and sellers to add their product to our system and choose several filters as to pricing, GEO targeting, condition and several variables. Items can be added by individuals, or will be able to be sent to us in bulk from 3^{rd} party buyers, sellers or watchers through our API. Our search/match engine then looks for matches based on the criteria and allows alerts/leads to potential matches and then allows the user methods of communication of the matched item or sales lead.

The claimed invention differs from what currently exists. Other systems in this field make the user search themselves for matches, and then they only have direct contact based on the results delivered. Our software can be set to find matches/leads and deliver them to the other party wanting to buy or sell the item based on the variables. We then allow for the user to choose how the communication will be handled between the two parties down to a managed system available from service.

This invention is an improvement on what currently exists. Other systems in this field make the user search themselves for matches, and then they only have direct contact based on the results delivered. Our software can be set to find matches and deliver them to the other party wanting to buy or sell the item based on the variables. We then allow for the user to choose how the communication will be handled between the two parties down to a managed system available from service. Other problems are the fact you have to keep searching several different sites, and if selling they also will have time constraints and make you relist your item. Our system will allow you to set your buy, sell or watch for as long as you want the system to do it. This is a huge time saver, and money saver.

People have to do more work themselves and abandon these websites at a high level. They don't feel comfortable giving their information out, and if they do, many times no communication is received back from the original party.

We will allow them to list their own wants and needs and variables on the item they want. Our search/match engine will constantly be looking for matches and then based on the users variable settings contact them with alerts/leads allowing for them to then choose a communication method on matches/leads.

Also, it can produce any place that people are doing searches for items to buy, sell and watch for and wanting to set variables on, to include such things as pricing, GEO targets, and the way they want to communicate with the potential match/lead.

### The Version of the Invention Discussed Here Includes:

1. Internet connection
2. Internet connection devise
3. Register with and email address
4. Choose a password
5. Add a user account
6. Add selling forms
7. Add buying forms
8. Add searching for forms (Watching)
9. Set alerts as desired
10. Choose variable settings for alerts/leads and communications
11. Choose what to do with matches and alerts/leads as they are received
12. Choose if you want managed services
13. Let our software do the watching for matches to be added
14. Purchase gateway
15. Ability to buy the match or lead
16. Users buy only the leads or matches they want when the chosen communication is completed

### Relationship Between the Components:

The buyers and sellers and watchers can be done in any order at any time. Items can be added and deleted in any order and at any time. This is all done in real time and on any internet connected devise. The communication between the parties can be done based on the user's settings in their own account. The users control the process unless they choose managed solutions. Then we will provide those services based on the users settings.

### How the Invention Works:

A user will login with his email into our Portal web site and the email will be verified. After verifying the email a password will be chosen which will have a secure and complex setting. We will allow login from some social networks too. After the user has set up their account, they then can add automobile, RV, Marine, Motorcycle and other vehicle motorsport type items to buy, sell, or watch. We also want to make this available to vertical markets like Real Estate. Really any application where a person would want to buy, sell, or look for matches based on variable like price, geo targets, condition, miles or other available choices based on the product type. There will be forms allowing for the items to be added based on the product type. There will be pricing tools built in. There will be settings for alerts/leads. There will be a phone number set up by our application that will allow for the communication between potential buyers and sellers which will have recording and reporting built in. This will allow for privacy, and contact information to be obtained. The user will be able to set up alerts on all the different channels that they want notifications on. They could be buying, selling and watching in any order at any time. If our system finds a match based on our patented algorithms and software process method it will notify the users based on their settings in their own portal. They will choose who, what, where and when a potential match or lead is a match based on different levels of importance. At that point in time they can decide to move further down the funnel to make contact with the match or lead. If they decide to do that they will be charged depending on variables in user types, membership rolls and user options. It also will require international languages. We plan on using this as a global portal.

The invention has numerous if-then, relationships and objects, and algorithms needed to run all the steps in the prior pages. More detail will be described in the utility patent.

### How to Make the Invention:

It will require the whole process method and coding internet based software, to include database, web service calls, front end graphic user interface and API's. It will require a dedicated IP address, a Web site domain name, SSL certificate and a merchant account with a payment gateway. It also will require international languages.

It will require coding internet based software, to include database, web service calls, front end graphic user interface and API's. It will require a dedicated IP address, a Web site domain name, SSL certificate and a merchant account with a payment gateway. It also will require international languages. Same as above.

The software code could be written without using web service calls and API's. It also could be written in several different software languages.

### How to Use the Invention:

Users could add the items they want to sell, buy or watch, and forget about having to do their own searching for the items to meet the criteria they want at the level of importance they want. So it's more of a set it and wait for matches to happen, and then get notified. After that you make the choice of if you want to move forward, or not, and how you want that communication to take place. By phone, text, chat, video, email or in person.

Additionally: It could be used in other buy, sell and watch of any products for sale. We see this working best in Automotive, RV, Marine, Motorsports and Real Estate as potential markets.

Also, it can create: Any place that people are doing searches for items to buy, sell and watch for and wanting to set variables on, to include such things as pricing, GEO targets, and the way they want to communicate with the potential match/lead.

1. A method for listing, matching, selling, buying and watching of a product where the parties involved choose the type of anonymous communication they want to connect with each other.

2. A method for the payment of the connection between the two parties, after they have agreed upon the connecting method.
